(19) United States
(12) Patent Application Publication
(10) Pub. No.: US 2003/0137513 A1
(43) Pub. Date: Jul. 24, 2003

(54) Apparatus and method for displaying status of port conditions

(76) Inventors: Chun-Hsiung Yin, Yungkang City (TW); Shu-Fen Ke, Taipei (TW); Wei-Chih Chen, Pingtung City (TW); Chieh-Yuan Cheng, Taoyuan City (TW)

Correspondence Address: SNELL & WILMER, ONE ARIZONA CENTER, 400 EAST VAN BUREN, PHOENIX, AZ, 850040001

(21) Appl. No.: 10/349,267

(22) Filed: Jan. 22, 2003

(30) Foreign Application Priority Data
Jan. 22, 2002 (TW) 091100930

(51) Int. Cl. G06T 11/20

(52) U.S. Cl. 345/440

(57) ABSTRACT

A status display apparatus for displaying conditions of a port is provided. The status display apparatus includes M display elements and a mask, wherein M≧2. Each display element corresponds to one of the conditions. The mask includes a first transparent portion of alphanumeric shape and (M−1) second transparent portions. The first transparent portion corresponds to one display element of the M display elements and the rest are (M−1) display elements. Each second transparent portion corresponds to one of the (M−1) display elements. The alphanumeric shape represents an identification code of the port, and the condition of the corresponding display element represents the connection status of the port. The (M−1) second transparent portions are arranged, in a geometry pattern, around the first transparent portion.

### CROSS REFERENCE TO RELATED APPLICATIONS

This application claims priority to Taiwan Patent Application No. 091100930 entitled “Apparatus for Displaying Status of Port Conditions and Method for Using the Same”, filed Jan. 22, 2002.

### FIELD OF INVENTION

The present invention generally relates to an apparatus and method for displaying status of port conditions and, more particularly, to a status display apparatus and method for displaying port conditions of a network switch.

### BACKGROUND OF THE INVENTION

A lot of electronic systems, such as data network systems, have displays that indicate the status of conditions in the system. In the example of Ethernet network, the display is used to indicate the status of certain conditions, such as whether a port of a network switch is connected, whether there is transmission or receipt activity at a port, or the indication of abnormal data delivery. One of the most popular display devices in electronic systems is a light emitting diode (LED) display.

As the electronic system becomes more complicated, the display must deliver information of a large number of conditions that are required for system management. In a conventional status display apparatus, displays corresponding to identification code of polls and port conditions are arranged in a matrix to deliver information. For example, in a multi-port switch having n ports and m different conditions for each of the ports, displaying each of the conditions for each of the ports requires a display of n×m LED elements arranged in a matrix on the panel of the switch. Referring to FIG. 1, a conventional status display apparatus 10 of a switch of sixteen ports 12 and three conditions 14 for each port is illustrated. In order to display each of the 3 different conditions for each of the 16 ports, a total 48 LEDs are needed and arranged in an 8×6 matrix on the front panel of the network switch. Generally, the identification codes of ports are printed on the panel, therefore, in a dim light environment such as a control room, it is not easy to identify conditions of each port. Moreover, when the large number of LEDs are arranged in a matrix, the front panel of a switch would be undesirably large.

Therefore, there is a need to provide a highly recognizable status display apparatus for a user to easily identify conditions in the system.

### SUMMARY OF THE INVENTION

The present invention is directed toward a status display apparatus for displaying conditions of a port that can be identified easily.

It is another object of the present invention that a status display apparatus of high-density arrangement is provided to reduce the area of the panel for accommodating the status display apparatus.

It is a further object of the present invention that a highly recognizable status display apparatus is provided for user to easily identify conditions of a port with illumination of display elements representing the identification code and indicating other conditions.

In a first embodiment, the present invention provides a status display apparatus for displaying conditions of a port. The status display apparatus includes M display elements and a mask. Each of the M display elements corresponds to one of the conditions, wherein M≧2. The mask includes a first transparent portion of alphanumeric shape and (M−1) second transparent portions. The first transparent portion corresponds to one display element of the M display elements and the rest are (M−1) display elements. Each of the (M−1) second transparent portions corresponds to one of the (M−1) display elements.

In the status display apparatus of the first embodiment, the alphanumeric shape represents an identification code of the port, and the condition of the corresponding display element indicates the connection status of the port. The (M−1) second transparent portions are arranged in a geometry pattern around the first transparent portion.

In a second embodiment, a status display apparatus for displaying conditions of a port includes M display elements and a mask. Each display element corresponds to one of the conditions, wherein M≧2. The mask includes a predetermined pattern element and M locations of the predetermined pattern element include M transparent portions. Each transparent portion corresponds to one of the M display elements. The predetermined pattern element includes a geometry pattern element. The M transparent portions are circularly arranged in the geometry pattern element.

In a third embodiment of the present invention, a status display apparatus for displaying conditions of a port includes M display elements and a mask. Each display element corresponds to one of the conditions, wherein M≧2. The mask includes M transparent portions. Each transparent portion is arranged to be surrounded by a next transparent portion and corresponds to one of the M display elements.

Furthermore, in the present invention, the M display elements at least display two colors to represent the conditions. The display element selectively blinks to represent the condition or represents the condition with illumination intensity. Moreover, at least two of the display elements cooperate with each other to represent the condition. The display element is a light emitting diode (LED).

In another embodiment of the present invention, a method for displaying (M+1) conditions of a port by using a status display apparatus is also provided, wherein M≧1. The status display apparatus includes a first display element, M second display elements, and a mask. The mask includes a first transparent portion corresponding to the first display element and M second transparent portions. Each second transparent portion corresponds to one of the M second display elements. The method includes the step of receiving a first control signal to display a connection condition of the port with the first transparent portion of alphanumeric shape. Then, M second control signals are received to display M conditions of the port with the M second transparent portions.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a conventional status display;

FIG. 2a illustrates a status display apparatus of the first embodiment of the present invention;

FIG. 2b illustrates the relative location of the transparent portions and the display elements of FIG. 2a;

FIG. 2c illustrates an alternate status display apparatus of the first embodiment;

FIG. 3a illustrates a status display apparatus of the second embodiment of the present invention;

FIG. 3b illustrates an alternate status display apparatus of the second embodiment;

FIG. 4a illustrates a status display apparatus of the third embodiment of the present invention;

FIG. 4b illustrates an alternate status display apparatus of the third embodiment; and

FIG. 5 illustrates a schematic view of switch panel with the status display apparatus of the present invention.

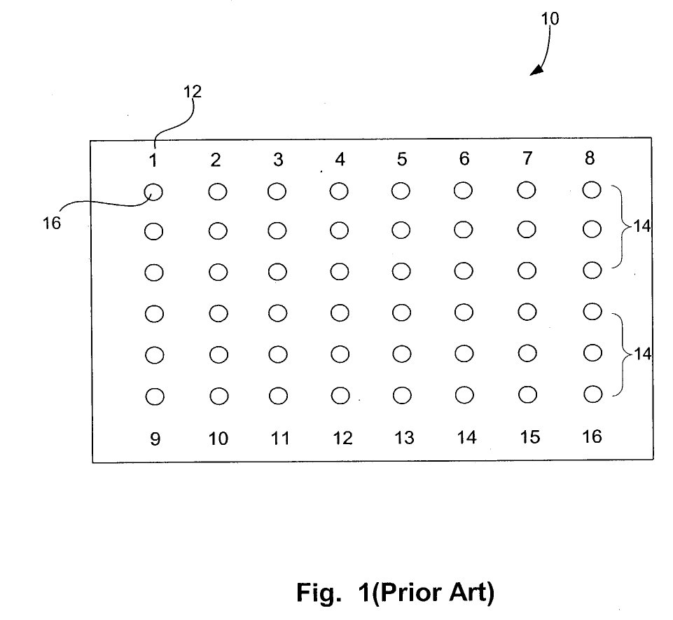

### DETAILED DESCRIPTION

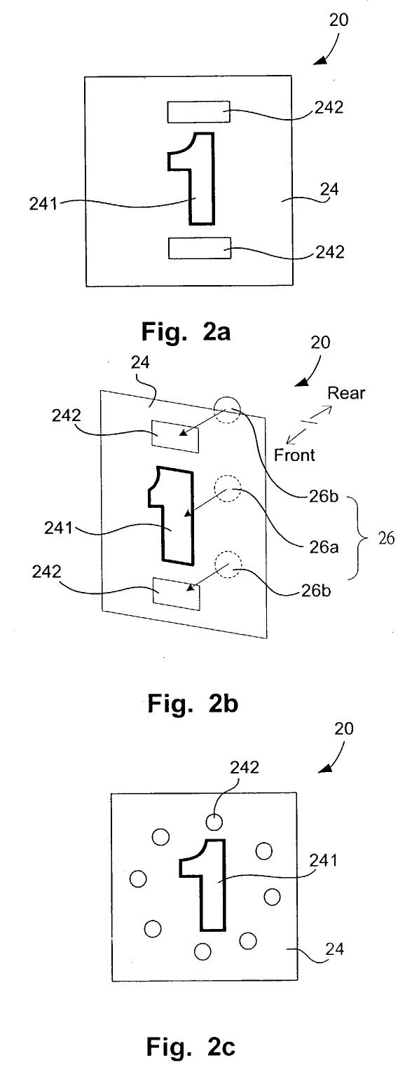

Referring to FIGS. 2a and 2b, in a first embodiment, the present invention provides a status display apparatus 20 for displaying conditions of a port. The status display apparatus 20 includes M display elements 26 and a mask 24. M is an integer greater than 2 or equal to 2 (M≧2), wherein M is 3 in this embodiment. The mask 24 can be attached to a panel of an electronic system or the mask 24 is the panel itself. A user views the port status directly from the front side of the mask 24, therefore, the display elements 26 are disposed in the rear side of the mask 24. Each of the M display elements 26 corresponds to one of the conditions. The mask 24 includes a first transparent portion 241 of alphanumeric shape and (M−1) second transparent portions 242. The first transparent portion 241 corresponds to one display element 26a and the rest are (M−1) display elements 26b. Each of the (M−1) second transparent portions 242 corresponds to one of the (M−1) display elements 26b. The display elements 26 are, for example, light emitting diodes (LED).

In the status display apparatus 20 of the first embodiment, the alphanumeric shape represents an identification code of the port, and the condition of the corresponding display element 26a indicates the connection status of the port. The alphanumeric shape can be any symbol capable of identifying the port, such as Arabic numeral, Roman numeral, Alphabet, and so on. The (M−1) second transparent portions 242 are arranged in a geometry pattern around the first transparent portion 241, as shown in FIG. 2c. Refer to FIG. 2c, which is an alternate status display apparatus of the first embodiment. Multiple second transparent portions 242 are arranged around the first transparent portion 241 in a circle. The second transparent portions 242 being arranged around the first transparent portion 241 in a triangle or other pattern is still in the scope of the present invention.

Furthermore, As shown in FIG. 2b, the two display elements 26b cooperate with each other to represent the condition of the port. For example, the upper display element 26b represents a first data transit condition of the port and the lower display element 26b a second data transit condition. During a normal operation, the upper and lower display elements 26b don't indicate conditions at the same time. When an abnormal operation is occurred, the upper and lower display elements 26b cooperate with each other to represent the abnormal condition.

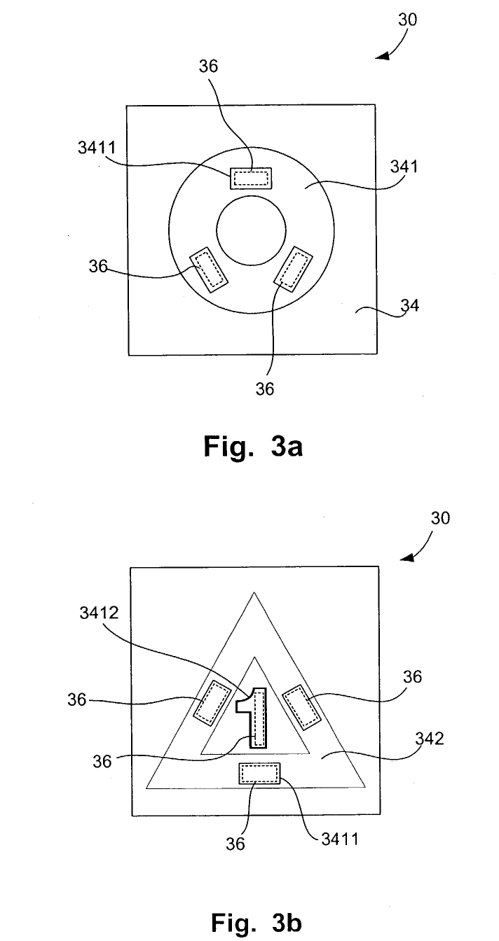

Referring to FIG. 3a, in a second embodiment, a status display apparatus 30 for displaying conditions of a port includes M display elements 36 and a mask 34, wherein M≧2 and M is 3 in this embodiment. The mask 34 is attached to a panel of an electronic system or the mask 34 is the panel itself A user views the port status directly from the front side of the mask 34, therefore, the display elements 36 are disposed in the rear side of the mask 34. Each display element corresponds to one of the conditions. The mask 34 includes a predetermined pattern element 341. M locations of the predetermined pattern element 341 include M transparent portions 3411. Each transparent portion 3411 corresponds to one of the M display elements 36. The predetermined pattern element 341 is a geometry pattern element. The M transparent portions 3411 are circularly arranged in the geometry pattern element. As shown in FIG. 3a, the 3 transparent portions 3411, corresponding to 3 display elements 36, are respectively disposed in 3 locations of the circle element 341. FIG. 3b illustrates an alternate status display of the second embodiment. The 3 transparent portions 3411, corresponding to 3 display elements 36, are respectively disposed in 3 locations of the triangle element 342. The alternate status display apparatus further includes a transparent portion 3412 of representing the identification code of the port. The transparent portion 3412 is disposed in the middle of the triangle element 342. The condition of the corresponding display element of the transparent portion 3412 is the connection status of the port.

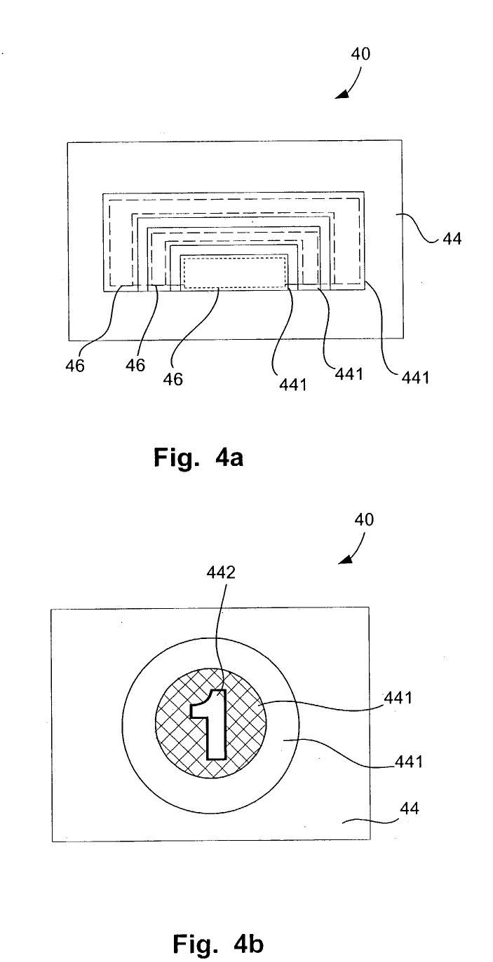

Referring to FIG. 4, in a third embodiment, a status display apparatus 40 for displaying conditions of a port includes M display elements 46 and a mask 44. Each display element 46 corresponds to one of the conditions, wherein M≧2. The mask 44 includes M transparent portions 441. Each transparent portion 441 is arranged to be surrounded by a next transparent portion 441 and corresponds to one of the M display elements 46. The mask 44 is attached to a panel of an electronic system or the mask 44 is the panel itself. A user views the port status directly fi-om the front side of the mask 44, therefore, the display elements 46 are disposed in the rear side of the mask 44. The M display elements 46 displaying two colors to represent the conditions respectively correspond to two of adjacent M transparent portions 441. FIG. 4b is the alternate status display apparatus of the third embodiment. The alternate status display apparatus further includes a transparent portion 442 capable of identifying the port. The identification transparent portion 442 is arranged to be surrounded by a first transparent portion 441 and the first transparent portion 441 is surround by a next transparent portion 441.

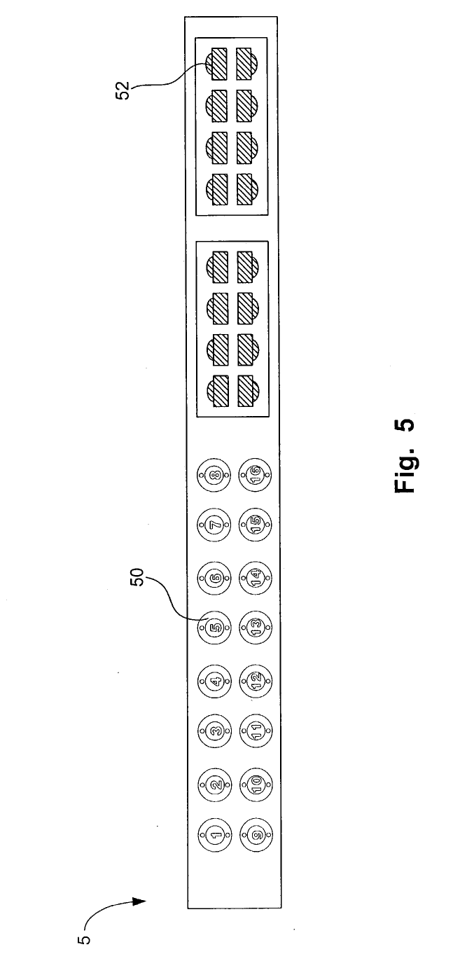

Please refer to FIG. 5, which illustrates a schematic view of switch panel 5 with the status display apparatus 50 of the present invention. As shown in FIG. 5, an electronic system, such as an Ethernet switch, has 16 ports 52. Each port 52 corresponds to a status display apparatus 50 of the present invention, such as the status display apparatus, 20,30, and 40 described in the first, the second, and the third embodiments, and in the alternate embodiments. Therefore, in a dim light environment, user can easily identify conditions of a port with illumination of display elements representing the identification code and indicating other conditions. The area of the panel 5 for accommodating the status display apparatus 50 is also reduced.

The M display elements of the present invention can at least display two colors, such as yellow and green colors, to represent the conditions. The display element selectively blinks to represent the condition, for example, blinking to indicate a data transit activity is processed. The display element represents the condition with illumination intensity. For example, when there is a transmission or receipt activity at the port, the display element lightens. When there is no activity or no connection at the port, the display element darkens. The display element can be a light emitting diode (LED) of any suitable size or shape. Furthermore, at least two of the display elements in the status display of the present invention cooperate with each other to represent the condition.

In another embodiment of the present invention, a method for displaying (M+1) conditions of a port by using a status display apparatus is also provided, wherein M≧1. The status display apparatus includes a first display element, M second display elements, and a mask. The mask includes a first transparent portion corresponding to the first display element and M second transparent portions. Each second transparent portion corresponds to one of the M second display elements. The method includes the step of receiving a first control signal to display a connection condition of the port with the first transparent portion of alphanumeric shape. Then, M second control signals are received to display M conditions of the port with the M second transparent portions.

Although specific embodiments have been illustrated and described, it will be obvious to those skilled in the art that various modifications may be made without departing from what is intended to be limited solely by the appended claims.

What is claimed is:

1. A status display apparatus for displaying conditions of a port, comprising:
M display elements, each display element corresponding to one of said conditions, wherein M≧2; and
a mask, said mask comprising:
a first transparent portion of alphanumeric shape, said first transparent portion corresponding to one display element of said M display elements, the rest being (M−1) display elements; and
(M−1) second transparent portions, each second transparent portion corresponding to one of said (M−1) display elements.

2. The status display apparatus according to claim 1, wherein said alphanumeric shape represents an identification code of said port, said condition of said display element, corresponding to said first transparent portion, represents connection status of said port.

3. The status display apparatus according to claim 1, wherein said (M−1) second transparent portions are arranged around said first transparent portion.

4. The status display apparatus according to claim 3, wherein said (M−1) second transparent portions are arranged in a geometry pattern around said first transparent portion.

5. The status display apparatus according to claim 4, wherein said (M−1) second transparent portions are arranged in a circle.

6. The status display apparatus according to claim 1, wherein said M display elements at least display two different colors to represent said conditions.

7. The status display apparatus according to claim 1, wherein said display element selectively blinks to represent said condition.

8. The status display apparatus according to claim 1, wherein said display element represents said condition with illumination intensity.

9. status display apparatus according to claim 1, wherein at least two of said display elements cooperate with each other to represent said condition.

10. The status display apparatus according to claim 1, wherein said display element is a light emitting diode (LED).

11. A status display apparatus for displaying conditions of a port, comprising:
M display elements, each display element corresponding to one of said conditions, wherein M≧2; and
a mask, said mask comprising a predetermined pattern element, M locations of said predetermined pattern element comprising M transparent portions,
wherein each transparent portion corresponding to one of said M display elements.

12. The status display apparatus according to claim 11, wherein said predetermined pattern element comprises a geometry pattern element.

13. The status display apparatus according to claim 12, wherein said geometry pattern element is a circle element, M transparent portions are circled arranged in said circle element.

14. The status display apparatus according to claim 11, wherein said M display elements at least display two different colors to represent said conditions.

15. The status display apparatus according to claim 11, wherein said display element selectively blinks to represent said condition.

16. The status display apparatus according to claim 11, wherein at least two of said display elements cooperate with each other to represent said condition.

17. The status display apparatus according to claim 11, wherein said display element is a light emitting diode (LED).

18. A status display apparatus for displaying conditions of a port, comprising:
M display elements, each display element corresponding to one of said conditions, wherein M≧2; and
a mask, said mask comprising M transparent portions, each transparent portion being arranged to be surrounded by a next transparent portion,
wherein each transparent portion corresponding to one of said M display elements.

19. The status display apparatus according to claim 18, wherein said M display elements at least display two different colors to represent said conditions.

20. The status display apparatus according to claim 19, wherein said M display elements displaying two different colors to represent said conditions respectively correspond to two adjacent said M transparent portions.

21. The status display apparatus according to claim 18, wherein said display element selectively blinks to represent said condition.

22. The status display apparatus according to claim 18, wherein at least two of said display elements cooperate with each other to represent said condition.

23. The status display apparatus according to claim 18, wherein said display element is a light emitting diode (LED).

24. A method for displaying (M+1) conditions of a port by using a status display apparatus comprising a first display element, M second display elements, and a pattern mask, said pattern mask comprising a first transparent portion corresponding to said first display element and M second transparent portions, each second transparent portion corresponding to one of said M second display elements, M≧1, comprising:
receiving a first control signal to display a connection condition of said port with said first transparent portion of alphanumeric shape; and
receiving M second control signals to display M conditions of said port with said M second transparent portions.
